(19) United States
(12) Patent Application Publication
(10) Pub. No.: US 2010/0280986 A1
(43) Pub. Date: Nov. 4, 2010

(54) SYSTEMS AND METHODS FOR TAILORING ACUTE AND CHRONIC VIRAL INFECTION TREATMENTS TO INCREASE THE PROBABILITY OF "CURE" FOR A GIVEN SUBJECT

(75) Inventors: Eric Snoeck, Meerhout (BE); Pascal Francois Chanu, Lyon (FR); Timothy Goggin, Basel (CH); Nelson L. Jumbe, Mountain View, CA (US); Nicolas Frey, Mulhouse (FR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Roche Palo Alto, Palo Alto, CA (US)

(21) Appl. No.: 12/435,263

(22) Filed: May 4, 2009

(51) Int. Cl. G06N 5/02; G06G 7/60

(52) U.S. Cl. 706/54; 703/11

(57) ABSTRACT

In various embodiments, systems and methods are provided for increasing the likelihood of a sustained virological response or “cure” using a model of patient physiology incorporating a subjects race, gender, age, weight, concomitant medicines and disease state, immune response status, and responsiveness to drug therapies to simultaneously characterize the change in viral burden in the subject in terms of velocity of viral load decline. In an embodiment, once viral load in a subject is below a physical measurement limit, the model can extrapolate the subject's observed viral velocity toward a physiological target shown to be highly correlated with “cure.” In further embodiments, the model can be used for personalized medicine—“the right drug at the right dose for the right treatment duration for the right patient.” Accordingly, the model can provide optimal value for treatment and reducing the high cost of side effects.

### BACKGROUND OF THE INVENTION

According to the World Health Organization, near the end of 2008, an estimated 170 million people or 2.1% of the world population are currently infected with hepatitis C virus. This number of infections may be more than four times the number of people living with HIV. While no vaccine against hepatitis C is currently available, the symptoms of infection can be medically managed. Additionally, patients can be cleared of the virus by a course of anti-viral medicines. The National Institute of Health suggests the current standard of care for patients with chronic hepatitis C (CHC) can include the combination of pegylated interferon a with ribavirin for period of 24 or 48 weeks, depending on genotype.

Sustained “cure” or sustained virological response (SVR) of 75% or better can occur in people with genotypes HCV 2 and 3 in 24 weeks of treatment, about 50% in those with genotype 1 with 48 weeks of treatment and 65% for those with genotype 4 in 48 weeks of treatment. Overall rates of SVR, defined as undetectable HCV RNA 24 weeks after treatment completion, of up to 66% have been obtained with an optimal regimen of peginterferon α-2a plus ribavirin in treatment-naïve patients in large, randomized, multicentre trials.

As suggested above, patients infected with HCV genotype 1, which represent about 70% of CHC patients in the U.S., are less likely to achieve an SVR than genotype non-1 infected patients. Approximately 50% of HCV genotype 1 infected patients generally achieve an SVR when treated with peginterferon α-2a plus ribavirin, whereas approximately 80% of HCV genotype non-1-infected patients generally achieve an SVR despite receiving a shorter treatment duration and a lower ribavirin dose. Thus, HCV genotype 1 patients represent a population with an unmet medical need, and have the potential to achieve a higher SVR rate from an improved treatment.

A significant question in the care of patients with both acute and chronic viral infections, such as HCV/HBV, Dengue, or even avian flu, is the time waiting to determine whether patients are responding to a given treatment.

Many viral diseases are asymptomatic during acute infection, and thus the diagnosis of is rarely made until after a subject has become chronically infected. The hepatitis C virus (HCV), for example, is usually detectable in the blood within one to three weeks after infection, and antibodies against HCV are generally detectable within 3 to 12 weeks. It is thought that between 15-40% of persons infected with HCV clear the virus during the acute phase of infection (defined as within the first six months of infection, or spontaneous viral clearance[REF]). The remaining 60-85% of patients infected with HCV develop chronic hepatitis C.

While the diagnosis of acute HCV is difficult, the diagnosis of chronic HCV is also challenging due to the absence or lack of specificity of symptoms until advanced liver disease develops. Unfortunately, this frequently does not occur until decades into the disease. Anti-HCV antibodies indicate exposure to the virus, but do not determine if ongoing infection is present. Persons with positive anti-HCV antibody tests must also undergo additional testing for the presence of the hepatitis C viral nucleic acid to determine if they are actively infected. The presence of the virus can be tested for using molecular nucleic acid testing methods such as polymerase chain reaction (PCR), transcription mediated amplification (TMA), or branched DNA (b-DNA). These HCV nucleic acid molecular tests have the capacity to detect not only whether the virus is present, but also to measure the amount of virus present in the blood (the HCV viral load). The HCV viral load itself indicates neither disease severity nor the likelihood of disease progression, additionally, there may be some quantification limits utilizing existing measurement techniques. However, viral load can be an important factor in determining the probability of response to interferon-based therapy.

The inventors recognize that baseline viral load may be a potent indicator of response to therapy-particularly immunologically biased therapies such as those containing PEGASYS, as it serves to integrate the patient's ongoing immunologic response to viral infection together with the viruses capacity to evade the host immune responses. Accordingly, what is desired is to solve problems relating to tailoring acute and chronic viral infection treatments for predictive algorithms which utilize viral kinetics as the foundation for their clinical claims will be able to define subjects most likely to respond to treatment, and thus permit clinicians to tailor therapy on a more individualized basis.

### BRIEF SUMMARY OF THE INVENTION

In various embodiments, systems and methods are provided for increasing the likelihood of a sustained virological response or “cure” using a model of patient physiology incorporating a subjects race, gender, age, weight, concomitant medicines and disease state, immune response status, and responsiveness to drug therapies to simultaneously characterize the change in viral burden in the subject in terms of velocity of viral load decline. In an embodiment, once viral load in a subject is below a physical measurement limit, the model can extrapolate the subject's observed viral velocity toward a physiological target shown to be highly correlated with “cure.” In further embodiments, the model can be used for personalized medicine—“the right drug at the right dose for the right treatment duration for the right patient.” Accordingly, the model can provide optimal value for treatment and reducing the high cost of side effects.

In one embodiment, a method for treating subjects having viral infections is provided to increase the probability of a predetermined clinical outcome. An antiviral drug can be administered to a subject having a viral infection, such as that of the liver in the case of hepatitis C (HVC), hepatitis B (HBV), dengue fever, avian flu, or the like. Administration of the antiviral drug may form part of a combination of treatments. Measurements may be obtained of viral load in the subject before, during, or after the administration of the antiviral drug. In an embodiment, viral load of the subject may be obtained during a first time period where at least one time point in the first time period occurs subsequent to administering the antiviral drug.

Velocity of viral load decline in the subject can be determined for the first time period. A determination or prediction can be made whether viral load in the subject after a second time period subsequent to the first time period passes a cure threshold based on a non-linear mixed-effects model of the viral disease. The model may model or otherwise predict viral load in the subject for the second plurality of time points using the velocity of viral load decline in the subject for the first time period. A dosing regimen associated with the antiviral drug can then be altered for the subject based on whether viral load in the subject passes the cure threshold.

In an embodiment, the velocity of viral load decline in the subject for the first time period may be determined by calculating the rate at which the viral load in the subject decreases at the at least one time point occurring subsequent to administering the antiviral drug. The model further may be used to determine viral load in the subject during one or more time points in the second plurality of time points occurring when viral load in the subject fails to satisfy a limit of quantification. In a further embodiment, viral kinetics (including infection activity and liver activity) may be simulated using the model to determine viral load in the subject during one or more time points in the second plurality of time points. In some embodiment, a profile may be determined for the subject using the model. The profile for the subject may be compared to a clustering of members of a population represented by the model.

In further embodiments, the non-linear mixed-effects model may represent the hepatitis C virus (HCV) or the hepatitis B virus (HBV). Altering the dosing regimen associated with the antiviral drug for the subject may include one or more of modifying dose of the antiviral drug, modifying a dose schedule for the antiviral drug, modifying a treatment duration, modifying a treatment combination, or removing the antiviral drug from the treatment of the subject and administering a different antiviral drug to the subject.

In various embodiments, a computer-readable storage medium may be configured to store one or more software programs which when executed by a information processing device or computer system cause the information processing device to perform the steps recited in the above method.

In yet another embodiment, a method is provided for assisting in the treatment of subjects having liver viral infections. Data for a subject infected with a virus attacking the liver may be received at an information processing device or computer system. In an embodiment, the data can may specify at least viral load in the subject during a first time period where at least one time point in the first time period occurs subsequent to administration of an antiviral drug. A rate may be then determined at which viral load in the subject decreases for the first time period. Viral load in the subject can be predicted or estimated for a second time period that occurs subsequent to the first time period when viral load passes a physical degree of detection based on simulating subject physiology and virus patho-physiology using a non-linear mixed-effects model. A clinical outcome may be suggested in response to a correlation provided by the model between the rate at which viral load in the subject declines and when viral load in the subject for the second time period satisfies a predetermined threshold.

In an embodiment, an information processing device or computer system may generated information suggesting the clinical outcome. The information about the clinical outcome may include information indicative of a sustained viral response, information indicative of a partial viral response, information indicative of a null viral response, information indicative of a breakthrough response, or information indicative of a relapse.

A further understanding of the nature of and equivalents to the subject matter of this disclosure (as wells as any inherent or express advantages and improvements provided) should be realized by reference to the remaining portions of this disclosure, any accompanying drawings, and the claims in addition to the above section.

### BRIEF DESCRIPTION OF THE DRAWINGS

In order to better describe and illustrate embodiments and/or examples of any innovations presented within this disclosure, reference may be made to one or more accompanying drawings. The additional details or examples used to describe the one or more accompanying drawings should not be considered as limitations to the scope of any of the claimed inventions, any of the presently described embodiments and/or examples, or the presently understood best mode of any innovations presented within this disclosure.

FIG. 1 is an illustration of a treatment cycle for tailoring acute and chronic viral infection treatments to increase the probability of “cure” in one embodiment according to the present invention;

FIG. 2 is an illustration of a set of clinical outcomes for subjects with acute and chronic viral infections;

FIG. 3 is a flowchart of a method for adapting treatment for subjects to increase the probability of “cure” in one embodiment according to the present invention;

FIG. 4 depicts a model incorporating virus-drug-host interaction in one embodiment according to the present invention;

FIG. 5 is a flowchart of a method for modeling virus or host biomarker activity to increase the probability of “cure” in one embodiment according to the present invention;

FIG. 6 illustrates that the model of FIG. 4 can be used to link virus or host biomarker activity to a clinical outcome in one embodiment according to the present invention;

FIG. 7 illustrates observed and model-predicted long-term viral load profiles in 12 representative patients in one embodiment according to the present invention;

FIG. 8 illustrates a table of parameters for the model of FIG. 4 in one embodiment according to the present invention;

FIG. 9 illustrates boxplots of individual HCV viral kinetic model parameters as split by patient outcome in one embodiment according to the present invention;

FIG. 10 illustrates observed (black vertical lines) and model predicted SVR rates (transparent histogram) in one embodiment according to the present invention; and

FIG. 11 is a simplified block diagram of an information processing device or computer system that may be used to practice embodiments of the present invention.

### DETAILED DESCRIPTION OF THE INVENTION

In various embodiments, systems and methods are provided for increasing the likelihood of a sustained virological response or “cure” using a model of patient physiology incorporating a subjects race, gender, age, weight, concomitant medicines and disease state, immune response status, and responsiveness to drug therapies to simultaneously characterize the change in viral burden in the subject in terms of velocity of viral load decline. In an embodiment, once viral load in a subject is below a physical measurement limit, the model can extrapolate the subject's observed viral velocity toward a physiological target shown to be highly correlated with “cure.” In further embodiments, the model can be used for personalized medicine—“the right drug at the right dose for the right treatment duration for the right patient.” Accordingly, the model can provide optimal value for treatment and reducing the high cost of side effects.

In one embodiment, a viral kinetic model, such as for hepatitis C (HCV), hepatitis B (HBV), dengue fever, or avian flu, can be used to explain the complexity and diversity of individual viral kinetic profiles of subjects as measured during and after treatment with a drug or combination of drugs. In comparison to many other disease states, viral infection frequently presents a uniquely efficient biomarker: Viral Load. In HCV, for example, there is thought to be no cellular reservoir outside of the hepatocyte cytoplasm. Additionally, the half-life of the viral RNA and viral particle is such that the virus requires ongoing efficient replication to maintain its presence in a host. As a result, in some embodiments, viral load can be used to provide an integrated “read out” of the combination of viral replication efficiency and host response.

In various embodiments, changes to either viral replication efficiency and host response can be used to alter the final viral load. Thus, treatment with a direct acting antiviral with profound viral suppressive properties can produce a change in viral load, just as immuno-modulatory therapy with weaker direct viral effects. As discussed further herein, a sustained viral decline can be a positive predictive marker of recovery from disease. Accordingly, with this decline in viral load, patient long term clinical outcomes can be dramatically improved (manifest, for example, by lower rates of cirrhosis, and hepatocellular carcinoma).

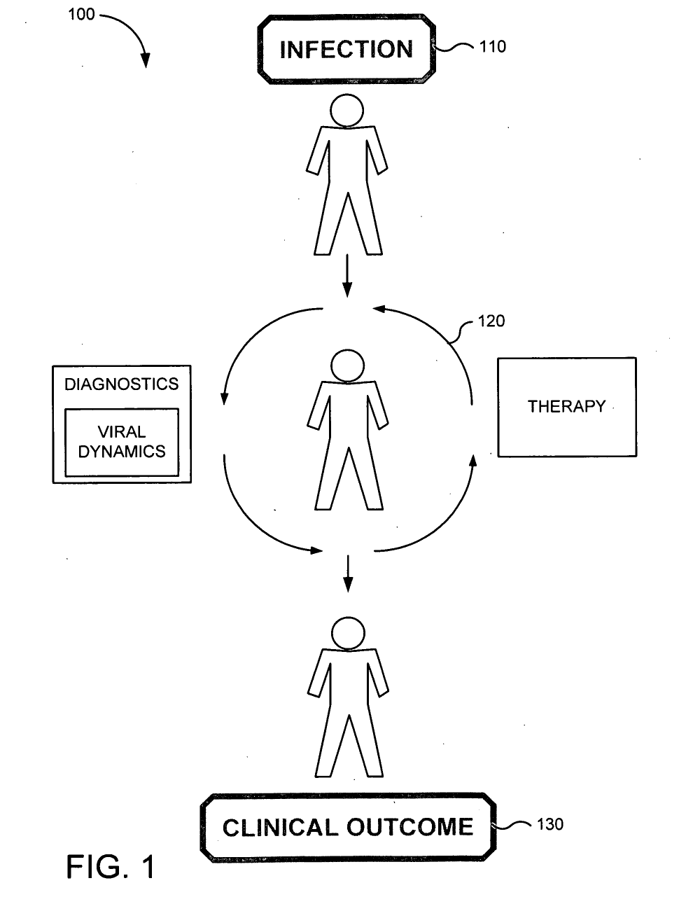

FIG. 1 is an illustration of treatment cycle 100 for tailoring acute and chronic viral infection treatments to increase the probability of “cure” in one embodiment according to the present invention. As discussed above, a diagnosis can be made for a patient with an acute and/or chronic viral infection 110, such as HCV, HBV, dengue fever, or avian flu. The diagnosis can be made during the acute phase or chronic phase of the disease. The patient may begin receiving one or more antiviral drugs or combined drug therapies during treatment 120 in an attempt to invoke a sustained virological response or “cure” the patient.

Before, during, or after administration of an antiviral drug or other therapy for treatment 120, one or more diagnostics may be performed to determine clinical outcome 130. For example, one or more diagnostics may be performed in an attempt to determine what therapy to provide, whether a give therapy is effective, whether the patient has been cured, or the like. For example, the patient may be given a series of tests or other diagnostics before beginning treatment to determine the type and extent of the infection. The patient may be treated based on the test results with a single therapy or a combination of drugs, therapies, or the like. In another example, the patient may be given a series of tests or other diagnostics during a treatment to determine effects of the treatment on the patient, such as measuring one or more biomarkers of disease activity.

In various embodiments, techniques associated with viral dynamics may be used during treatment 120 to increase the likelihood that one or more therapies will result in a sustained virological response (SRV) or “cure” as clinical outcome 130. For example, viral dynamics may be modeled or simulated during a therapy to provide important insights into the life cycle of a given virus elucidating the kinetic parameters governing viral infection and death of infected cells, the antiviral effects of interferons, and how anti-viral drugs (e.g., ribavirin) impact specific treatments. In some embodiments, models of viral kinetics may provide a means to compare different treatment regimens with the clinical outcomes, such as a partial response or a sustained response, in different patient populations.

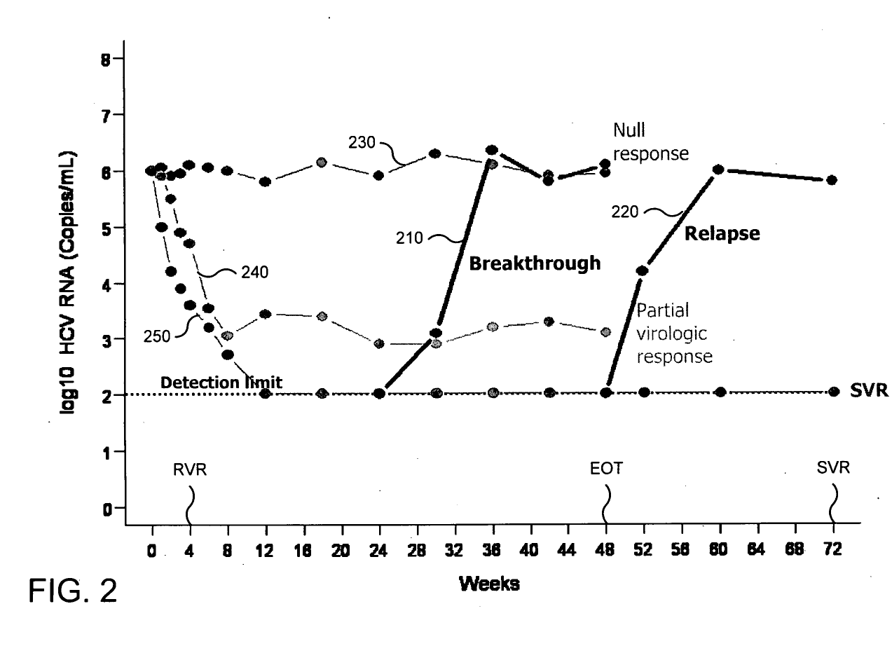

FIG. 2 is an illustration of a set of clinical outcomes for subjects failing treatment with chronic viral infections in one embodiment. For example, viral load in subjects can rebound to pretreatment levels during therapy in what is known as a “breakthrough” response (breakthrough response 210 of FIG. 2). In another example, viral load in subjects can return to pretreatment levels upon cessation of therapy in what is known as a “relapse” response (relapse response 220 of FIG. 2). In yet another example, viral load in subjects can over the long term remain relatively stable in what is known as a “null” response (null response 230 of FIG. 2). In a still further example, viral load in subjects can initially decline, yet remain relatively stable thereafter in what is known as a “partial” response (partial response 240 of FIG. 2). In another example, viral load in subjects can decline and remain undetected over the long term remain in what is known and a sustained virological response (SRV response 250 of FIG. 2). In various embodiments, each of the variable patient profiles that correspond to the set of clinical outcomes may be modeled to increase the probability of “cure.”

In various embodiments, systems and methods are provided for increasing the likelihood of a sustained virological response or “cure” using a model of patient physiology incorporating a subjects race, gender, age, weight, concomitant medicines and disease state, immune response status, and responsiveness to drug therapies to simultaneously characterize the change in viral burden in the subject in terms of velocity of viral load decline. In an embodiment, once viral load in a subject is below a physical measurement limit, the model can extrapolate the subject's observed viral velocity toward a physiological target shown to be highly correlated with “cure.” In other embodiments, differences between the different clinical outcomes can be studied for personalized medicine allowing “the right drug at the right dose for the right treatment duration for the right patient.” Accordingly, the model can provide optimal value for treatment and reducing the high cost of side effects.

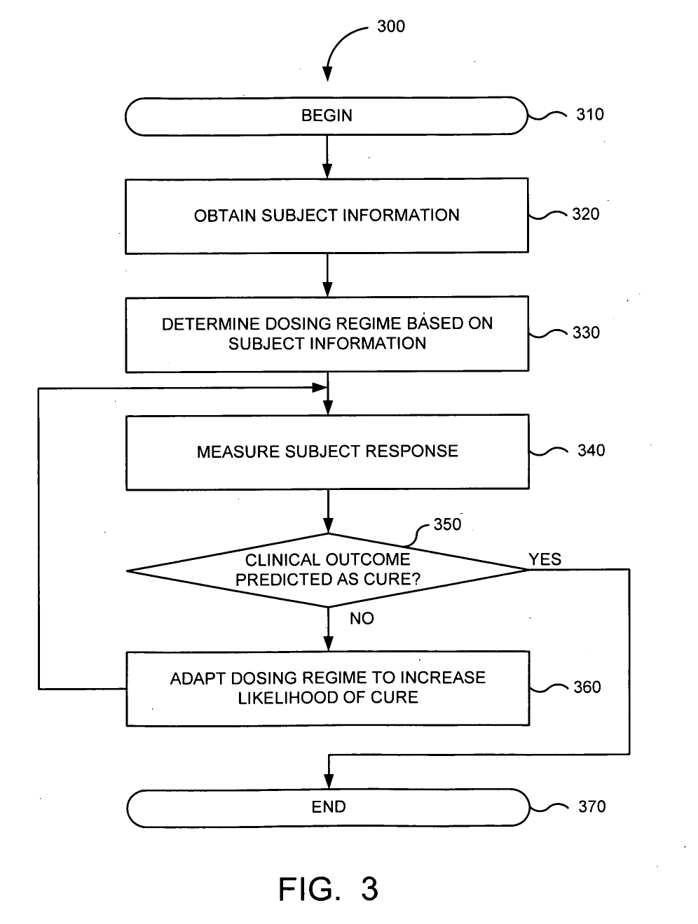

FIG. 3 is a flowchart of method 300 for adapting treatment for subjects to increase the probability of “cure” in one embodiment according to the present invention. Method 300 of FIG. 3 begins in step 310.

In step 320, information about a subject is obtained. The information may include a past medical history, family history, medicine allergies, drug/alcohol/tobacco use, dietary and social histories, a review of systems, history of present illness, genotype, phenotype, exam results, diagnostics and other test results, pathology, or the like. In step 330, a dosing regime is determined based on the information about the subject. The dosing regime may consider timing of administration of an drug or combination of drugs, amount of the drug or combination of the drug, or other factors.

In step 340, subject response is measured. In some embodiments, various diagnostics or other tests may be performed to determine virological response of the subject. In further embodiments, measurements of biomarkers relevant to disease activity may be taken. For example, viral load in the subject can be measured. In an embodiment, viral load in the subject measured over time can be used to determine whether the clinical outcome of the dosing regime is predicted as a cure in step 350. If the clinical outcome of the dosing regime is not predicted as a cure, in step 360, the dosing regime is adapted to increase likelihood of a cure. Method 300 then may repeat until the clinical outcome of the dosing regime is predicted as a cure in step 350. Method 300 ends in step 370 if the clinical outcome of the dosing regime is predicted as a cure in step 350.

In various embodiments, techniques associated with viral dynamics may be used, for example in the prediction step 350 of FIG. 3, to increase the likelihood that one or more therapies will result in a sustained virological response (SRV) or “cure.” As discussed above, modeling virus dynamics during therapy can lead to important insights into the life cycle of a given virus elucidating the kinetic parameters governing viral infection and death of infected cells, the antiviral effects of interferons, and how anti-viral drugs (e.g., ribavirin) impact specific treatments. A prediction or simulation of viral load using the model may provide an integrated “read out” of the combination of viral replication efficiency and host response. In situations where the direct anti-viral effects of a drug are at least additive with the antiviral effects of the immune system, treatment with a direct acting antiviral with profound viral suppressive properties but minimal immunomodulatory effects can produce a change in viral load, as well as immuno-modulatory therapy with weaker direct viral effects But more potent immuno-activating effects just as will In various embodiments, a sustained viral decline can be a positive predictive marker of recovery from disease.

In one example, a model of HCV infection was originally proposed by Neumann et al. in “Hepatitis C Viral Dynamics in Vivo and the Antiviral Efficacy of Interferon-a Therapy,” Science, Vol. 282, pages 103-107, October 1998 which is incorporated herein by reference for all purposes. In general, the Neumann model describes typical early therapy outcome characterized by an initial rapid viral decline followed by a second slower decline until HCV RNA becomes undetectable. The Neumann model has therefore been frequently used to describe viral load profiles after short-term treatment.

However, after long-term treatment with current standards of care, the HCV virus is generally not eradicated in approximately 50% of HCV genotype 1 patients and in approximately 20% of HCV genotype non-1 infected patients. In these patients, viral load either rebounds to pretreatment levels during therapy (breakthrough response 210 of FIG. 2), or returns to pretreatment levels upon cessation of therapy (relapse response 220 of FIG. 2). The Neumann model fails to describe or otherwise provide for these two phenomena, as well as a null response (null response 230 of FIG. 2), a triphasic viral decay, and a SVR (SRV response 250 of FIG. 2). In addition, the Neumann model which included three ordinary differential equations (ODE's) representing the population of target cells (hepatocytes), productively infected cells (infected hepatocytes) and virus was simplified, by assuming a constant population of hepatocytes which is known to be only valid for a short duration. Finally, the Neumann model omits all HCV RNA measurements below the lower limit of quantification (LLOQ) which can carry important modeling information for predicting long-term treatment outcome.

In various embodiments, population models can be provided as developed by nonlinear mixed effects analysis that simultaneously describe the individual long-term HCV kinetic profiles of subjects treated with peginterferon α-2a alone or in combination with ribavirin. In an embodiment, a population model may account for the ribavirin effect, the natural turnover and proliferation of hepatocytes, and the viral eradication. The population model further may account for HCV RNA measurements below the LLOQ. Population models can be adapted for hepatitis B virus (HBV) infection, dengue fever, avian flu, or the like, based on host response and viral replication for the given disease.

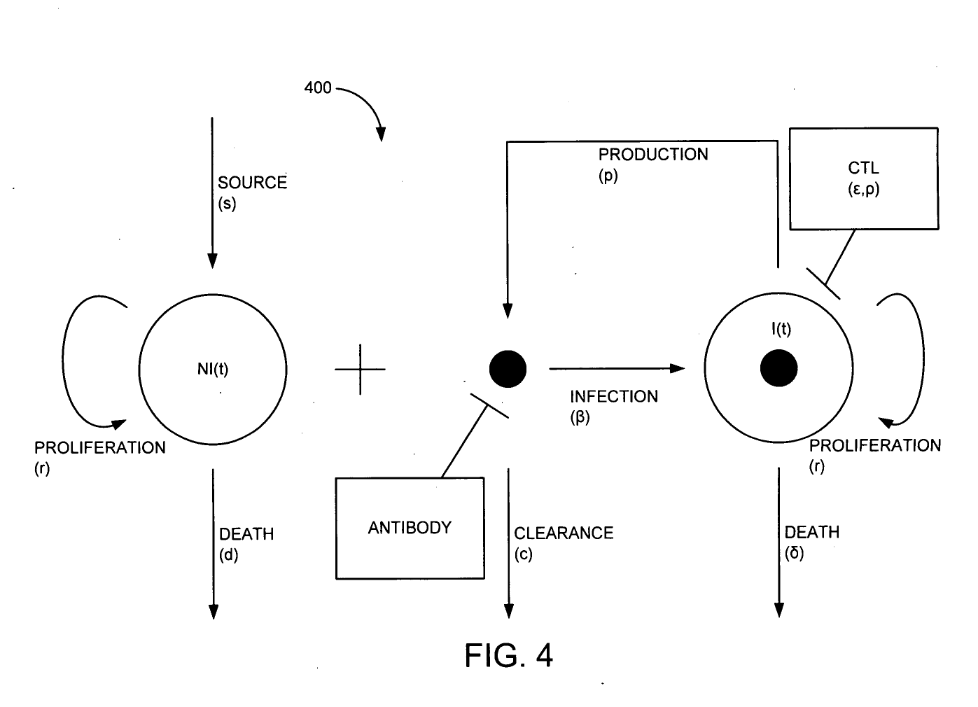

FIG. 4 depicts HCV viral kinetic model 400 incorporating liver physiology and viral activity in one embodiment according to the present invention. In this example, liver physiological/patho-physiology characteristics are incorporated into model 400, such as hepatocyte cell maturation (source s), death rate (death d), maximal liver size (Tₘₐₓ). Model 400 can be parameterization in terms of a reproductive ratio (RR₀) rather than cell infectivity (infection β). A “cure” boundary condition can be provided when a number of infected cells is predicted to be <=1.

In an embodiment, treatment dose can be used as an input into model 400 where the treatment effect is assumed to decrease according to:

ε^{-kt} (1)

HCV viral kinetic model 400 is extended with a density dependent proliferation of hepatocytes [r]. HCV viral kinetic model 400 further includes the effect of peginterferon α-2a [1−ε] on the virion production (p), and the effect of ribavirin rendering a fraction of newly produced virions non-infectious [ρ], formed the basis of the current population analysis:

$$\begin{matrix}\frac{d T}{d t} = s + r \cdot T \cdot ( 1 - \frac{T + I}{{T}_{max}} ) - d \cdot T - β \cdot {V}_{I} \cdot T & ( 2 ) \\ \frac{d I}{d t} = β \cdot {V}_{I} \cdot T + r \cdot T \cdot ( 1 - \frac{T + I}{{T}_{max}} ) - δ \cdot I & ( 3 ) \\ \frac{d {V}_{I}}{d t} = ( 1 - ρ ) \cdot ( 1 - ɛ ) \cdot p \cdot I - c \cdot {V}_{I} & ( 4 ) \\ \frac{d {V}_{NI}}{d t} = ρ \cdot ( 1 - ɛ ) \cdot p \cdot I - c \cdot {V}_{NI} & ( 5 )\end{matrix}$$

Infectious HCV virions (V_{I}) infect target cells (uninfected hepatocytes) [T] creating productively infected cells (I) at a rate β·V₁·T. Uninfected hepatocytes are produced at rate s and die at rate d. Infected hepatocytes die at rate δ. Infectious (V_{I}) and non-infectious (V_{NI}) virions are produced at rate p and cleared at rate c. The measured viral load (V) can be expressed in IU/mL, representing the sum of infectious and non-infectious virions V=V_{I}+V_{N}. Model 400 can further be extended with Eₘₐₓ dose-response models describing the dose-dependent effects of peginterferon α-2a and ribavirin:

$$\begin{matrix}ɛ = \frac{{Dose}_{PEG}}{{ED}_{{50}_{PEG}} + {Dose}_{PEG}} & ( 6 ) \\ ρ = \frac{{Dose}_{RBV}}{{ED}_{{50}_{RBV}} + {Dose}_{RBV}} & ( 7 )\end{matrix}$$

In this example, Dose_{PEG} is the weekly subcutaneous dose of peginterferon α-2a and ED₅₀_{_{PEG}} is the estimated weekly dose of peginterferon α-2a resulting in a 40% inhibition of the virion production. Continuing the example, Dose_{RBV} is the daily dose of ribavirin per kg body weight and ED₅₀_{_{RRV}} is the estimated daily dose in mg/kg rendering 40% of the virions non-infectious. In an embodiment, the offset of drug effect after stopping treatment can be described assuming an exponential decay in function of time (e^{-K·t}), where K is the estimated rate constant and t the time since the end of treatment.

In general, the maximum number of hepatocytes present in an individual liver is assumed to be 2.5·10¹¹ hepatocytes. As HCV RNA is distributed in plasma and extracellular fluids with a volume of approximately 13500 mL, the maximum number of hepatocytes in model 400 (e.g., Tₘₐₓ) is assumed to be 18.5·10⁶ cells/mL. In an embodiment, assuming a hepatocyte turnover in a healthy liver of 300 days, the death rate of target cells (d) can be set to 1/300 day⁻¹, and the production of new hepatocytes in the absence of liver disease (s) can be assumed to be 61.7·10³ cells·mL⁻¹ days⁻¹.

Non-linear mixed effects models generally include of a combination of fixed and random effects. In one example, individual parameters (PARᵢ) in such model disclosed herein can be described by:

PARᵢ=θ·e^{η}^{ₜ} (8)

In this example, the subscript i denotes individual, the fixed effects parameter θ represents the mean (typical) value of the parameter in the population, and ηᵢ, is the random effect accounting for the individual difference from the typical value. The ηᵢ values are assumed to be normally distributed in the population with a mean of zero and an estimated variance of ω². Individual parameter estimates are used to predict the viral load in an individual i at a certain point in time j (V_{pred,ij}). The measured viral load (V_{obs,ij}) differ from the predicted where:

V_{obs,ij}=V_{pred,ij}·exp(εᵢⱼ) (9)

The εᵢⱼ values are assumed to be normally distributed with a mean of zero and an estimated variance σ². The ω² quantifies the inter-individual variability (IIV) and the σ² quantifies the residual variability. Individual parameter estimates (PARᵢ) are assumed to be lognormally distributed, whereas the residual error was assumed to be multiplicative. Finally, the measured viral load data were log 10-transformed for one exemplary analysis.

In one embodiment, estimated fixed effects parameters of model 400 can include basic reproduction number (R₀), p, c, δ, liver proliferation rate r, ED₅₀_{_{PEG}}, ED₅₀_{_{RBV}}, and K. Inter-individual variability (IIV) can be incorporated on the parameters R₀, c , δ and ED₅₀_{_{PEG}}. In an embodiment, potential differences between viral kinetic parameters in HCV genotype 1 versus non-1 patients can be explored. In yet another embodiment, residual error can be assumed to be multiplicative and any analysis performed using log 10 transformed viral load data.

Population parameters of HCV viral kinetic model 400 can be estimated using the SAEM algorithm, as implemented in the MATLAB language using a software tool MONOLIX, available on the author's website (www.monolix.org). In one example, version 2.4 of MONOLIX and MATLAB version 7.6 running under Windows XP were used to estimate the fixed effects parameters and the variance of the random effects as well as the residual variability. In the example, S-PLUS version 6.2 was used for data file creation and goodness of fit assessments. Goodness of fit assessments revealed that individual viral load profiles of subjects in a population can be well described by model 400.

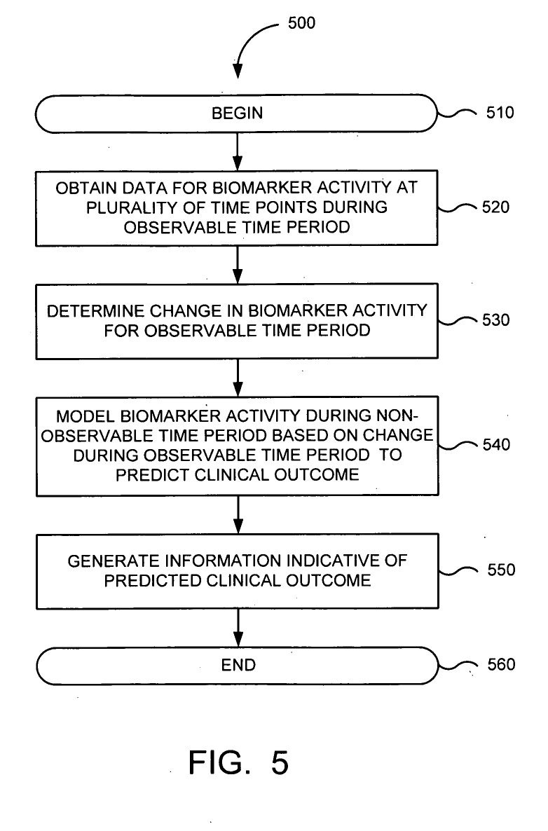

FIG. 5 is a flowchart of method 500 for modeling biomarker activity to increase the probability of “cure” in one embodiment according to the present invention. The processing of method 500 depicted in FIG. 5 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 500 depicted in FIG. 5 begins in step 510.

In step 520, data for biomarker activity is obtained at a plurality of time points during an observable time period. For example, measurements of viral load in a subject may be taken at various points in time. In general, the observable time period includes those measurements above a given detection limit, lower limit of detection, or LOD (limit of detection) when the lowest quantity of a substance can be distinguished from the absence of that substance within a predetermined confidence limit or threshold (e.g., 1%). In step 530, a change in biomarker activity is determined for the observable time period. Some examples of change can include a null change in biomarker activity, a decrease in biomarker activity, an increase in biomarker activity, or some combination.

In step 540, biomarker activity is modeled during a non-observable time period based on the change determined during the observable time period to predict a clinical outcome. The non-observable time period can include when the lowest quantity of a substance cannot be distinguished from the absence of that substance within a stated confidence limit. In one example, mathematical technique may be used that involve the simulation of missing data between 0 and a LLOQ, and then fitting observed data and simulated scatter data using information from direct observations. In an embodiment, a model such as model 400 is used to simulate a disease to determine biomarker activity that cannot be observed by measurement. The model can provide a link or correspondence between the change in biomarker activity determined during the observable time period and a clinical outcome using the simulated biomarker activity during the non-observable time period.

In step 550, information is generated indicative of the predicted clinical outcome. For example, a patient profile may be created indicating a predicting clinical outcome of a null response, a partial response, a breakthrough response, a relapse, or a sustained response or cure.

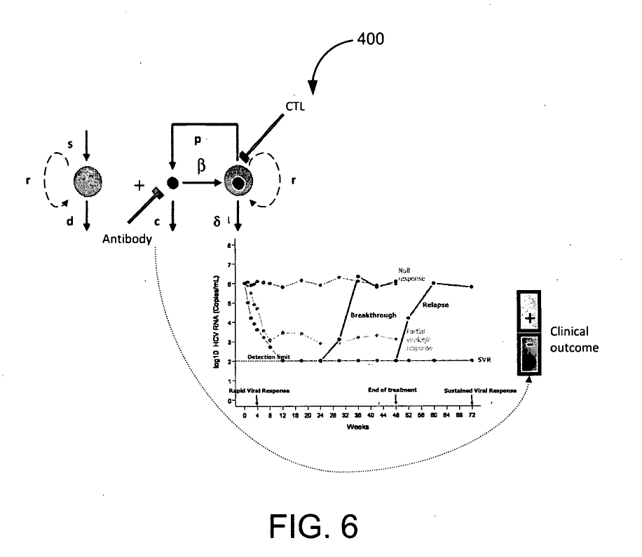

FIG. 6 illustrates that model 400 can be used to link model biomarker activity to a clinical outcome in one embodiment according to the present invention. In model 400, an indication of SVR that denotes cure or complete virion eradication can be provided by setting p to zero at the time point at which treatment results in less than one infected cell. Where the patient profile indicates a non-sustained virological response, suggested treatments, regimes, or other adaptations to the treatment of a subject may be provided. In another example, a profile may be determined for the subject. The profile for the subject may be compared to a clustering of members of a population represented by the model. FIG. 5 ends in step 560.

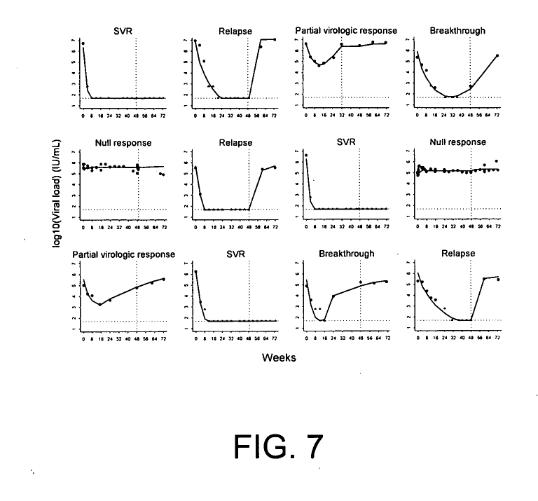

In one sampling, a selection of 12 individual viral load profiles shows that HCV viral kinetic model 400 can not only describe the initial decreases in viral load over the first month, but also the typical phenomena observed after long-term therapy. FIG. 7 illustrates observed and model-predicted long-term viral load profiles in 12 representative patients. In FIG. 7, solid lines illustrate the fits of model 400 to individual viral load data which are either detectable (closed circles) or below a LLOQ of 40 IU/mL (closed triangles). Dotted horizontal lines illustrate the LLOQ of the assay. Dotted vertical lines illustrate the end of treatment. HCV viral kinetic model 400 can describe all the typical phenomena observed after long-term therapy such as null response (no change in viral load), partial virologic response (initial decrease followed by increase during treatment), breakthrough during therapy (non-detectable viral load followed by increase during treatment), relapse after therapy (non-detectable viral load at the end of therapy followed by an increase during the treatment-free follow-up period), as well as an SVR (non-detectable viral load at 24 weeks after the end of therapy).

Inspection of individual parameter estimates in patients experiencing a breakthrough during therapy indeed showed that the administered drug therapy failed to decrease the basic reproduction number (R₀) below 1. According to our modeling assumptions, a treatment with either higher doses or a combination treatment with new drugs may be an option in these patients in order to try to get the R₀ below 1. The situation in patients having a relapse after the end of treatment may be twofold: i) on the one hand, relapsing patients may have had a R₀<1 during treatment, but were not treated long enough so that the viral load quickly returned back to baseline at the end of therapy, or ii) drug therapy may have failed to decrease the R₀ below 1. Extended treatment duration at the same drug combination, dose and schedule in relapsing patients may therefore be an option in the former situation but not in the latter. Based on these hypotheses, individual treatments may be optimized using model 400 when the individual R₀ and drug effect are known.

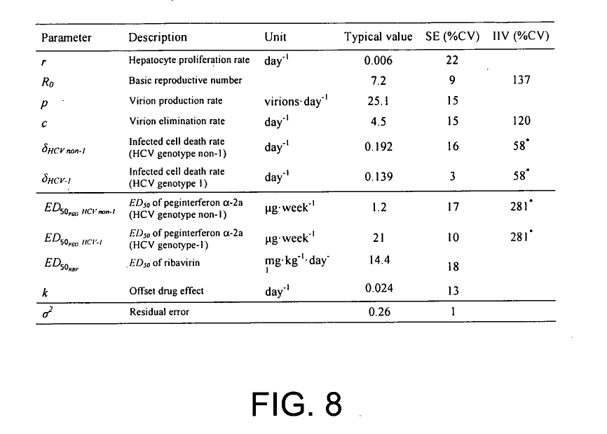

Continuing the previous example, parameters may be estimated with good precision. FIG. 8 illustrates a table of parameters for model 400 in one embodiment according to the present invention. In this example, population parameters of HCV viral kinetic model 400 are fitted to the individual long-term viral load profiles of 2100 patients receiving chronic treatment of peginterferon α-2a alone or in combination with ribavirin. The upper part of the table in FIG. 8 are system-specific parameters and the lower part of the table in FIG. 8 are drug-specific parameters. The SE reflects the precision of the estimated parameters and IIV represents the inter-individual variability.

In FIG. 8, the maximum hepatocyte proliferation rate (r) was 0.006 day⁻¹. In an embodiment, simulations based on this r revealed that the predicted liver regeneration matched well with the increase in original liver volume in 41 donors as measured 1 year after providing right-lobe liver grafts. The typical value of the R₀ was estimated to be 7.2 with an IIV of 137% CV. The relatively large IIV reflects the large difference in effect of peginterferon α-2a required to decrease the R₀ below 1. The typical value of the virion production rate p was 25.1 virions˜day⁻¹ and the free virion clearance rate c was estimated to be 4.5 day⁻¹, corresponding to a free virion half-life of 3.7 hours. This half-life lies within a reported range of 1.5-4.6 hours.

In various embodiment, no significant correlation was found between c and HCV genotype. In contrast, the infected cell death rate (δ) appeared to be dependent on HCV genotype, and the typical value was estimated to be 0.139 days in genotype-1 infected patients and 0.192 days in patients infected with HCV genotype non-1. These estimates appear to be in line with reported values of δ. In an embodiment, the higher δ in HCV genotype non-1 infected patients may indicate an enhanced immunological response. This can confirm a finding that a fast viral decay early in treatment is correlating with SVR. Also, the typical value of the ED₅₀_{_{PEG}} was found to be lower in HCV genotype non-1 patients as compared to patients infected with HCV genotype 1. This can confirm a finding for the higher antiviral effectiveness of peginterferon α-2a in blocking virion production in genotype non-1 patients. In one embodiment, the relatively large IIV reflects the large difference in antiviral effectiveness between patients. The ED₅₀_{RBV} was estimated to be 14.4 mg˜kg⁻¹·day⁻¹. This can correspond to rendering a fraction of 40-60% of the virions non-infectious for a standard ribavirin treatment of 1000/1200 mg per day. Finally, the residual error can be estimated to be 41% CV, which appears lower than the 62% CV obtained in another similar analysis of HIV viral load data.

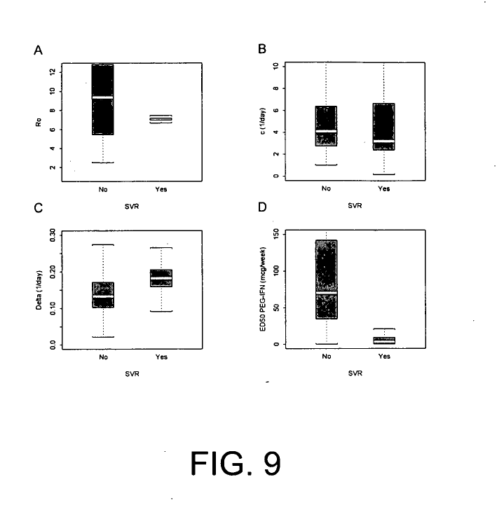

A comparison of the individual parameter estimates between patients with and without an SVR reveals that the R₀ and ED₅₀_{_{PEG}} are generally lower in SVR patients. FIG. 9 illustrates boxplots of individual HCV viral kinetic model parameters as split by patient outcome (i.e. SVR versus no-SVR patients). The basic reproduction number (R₀) is generally higher and more variable in patients without an SVR (A). The free virion clearance rate (c) is typically not different between patients with and without an SVR (B). The infected cell death rate (δ) is generally higher in patients with an SVR (C). The effectiveness of peginterferon α-2a in inhibiting the production of new virions is generally higher in patients with an SVR (D).

In an embodiment, a relatively low R₀ prior to treatment and a relatively high treatment effect will increase the likelihood of R₀<1 during treatment and will thus increase the likelihood of SVR. In a model-based analysis, the free virion clearance rate (c) did not appear to be a prognostic factor for SVR, whereas the death rate of infected cells (δ) was found to be higher in SVR patients indicating these patients may have an enhanced immunological response and thus a higher likelihood of viral eradication.

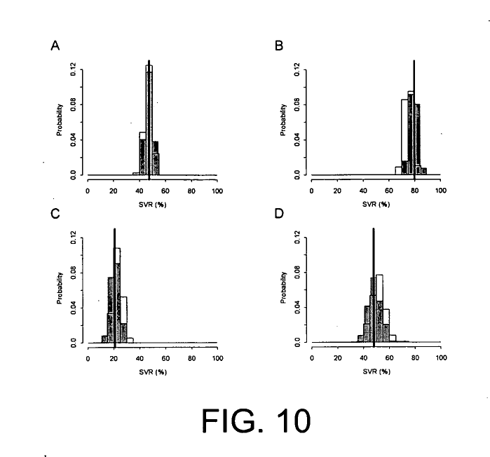

The predictive performance of model 400 was assessed by an external model evaluation procedure predicting the SVR rate of a large clinical trial not included in the model building dataset. This SVR rate was then compared with the observed SVR rate. FIG. 10 illustrates observed (black vertical lines) and model predicted SVR rates (transparent histogram) in one embodiment according to the present invention. In this example, 180 μg peginterferon α-2a was investigated once weekly for 48 weeks given alone or in combination with daily 1000 or 1200 mg ribavirin. The uncertainty of the observed SVR rates was quantified by bootstrapping (grey histograms). The observed SVR rate in 297 HCV genotype 1 patients receiving combination therapy falls within the range of model predicted SVR rates (A). The observed SVR rate in 154 HCV genotype non-1 patients receiving combination therapy also falls within the range of model predicted SVR rates (B). The observed SVR rate in 143 HCV genotype 1 patients receiving monotherapy of peginterferon α-2a falls within the range of model predicted SVR rates (C). Finally, also the observed SVR rate in 77 HCV genotype non-1 patients receiving monotherapy of peginterferon α-2a falls within the range of model predicted SVR rates (D). Therefore, model 400 was successfully qualified for further simulations as the predicted range of SVR rate in HCV genotype 1 and non-1 infected patients receiving 48 weeks of treatment with peginterferon α-2a alone or in combination with ribavirin matched well with the observed SVR rate in this study.

Accordingly, HCV viral kinetic model 400 was able to adequately describe all individual long-term viral load profiles of 2100 CHC patients receiving chronic treatment of peginterferon α-2a alone or in combination with ribavirin. In an embodiment, model 400 provides new insights and explanations for typical phenomena observed in the clinic such as breakthrough during therapy and relapse after stopping therapy. In another embodiment, model 400 may help to better understand current treatment success and failure, and can also be used to predict and evaluate the efficacy of alternative treatment options (e.g. alternative doses, durations and new drug combinations) in an overall patient population.

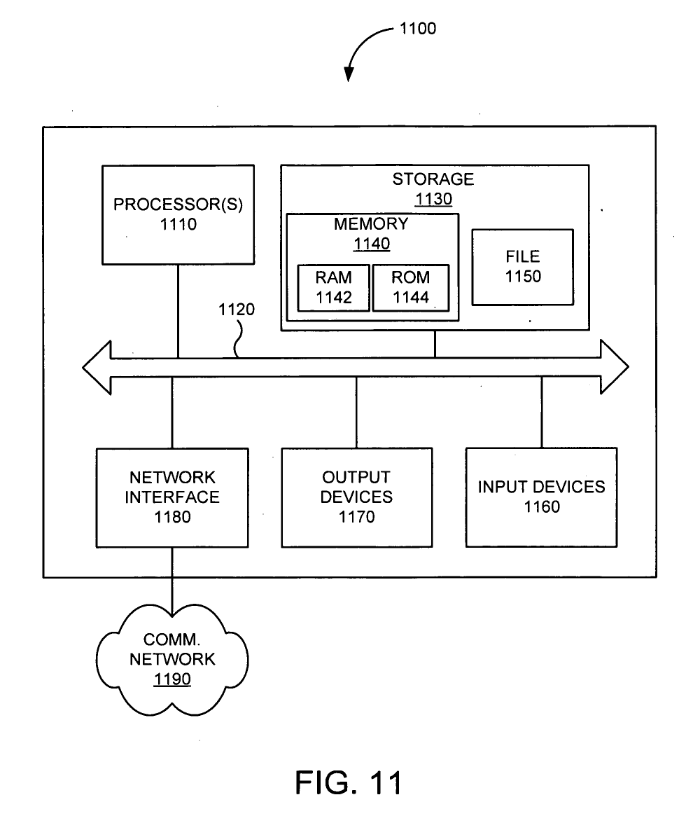

FIG. 11 is a simplified block diagram of computer system 1100 that may be used to practice embodiments of the present invention. As shown in FIG. 11, computer system 1100 includes processor 1110 that communicates with a number of peripheral devices via bus subsystem 1120. These peripheral devices may include storage subsystem 1130, comprising memory subsystem 1140 and file storage subsystem 1150, input devices 1160, output devices 1170, and network interface subsystem 1 180.

Bus subsystem 1120 provides a mechanism for letting the various components and subsystems of computer system 1100 communicate with each other as intended. Although bus subsystem 1120 is shown schematically as a single bus, alternative embodiments of the bus subsystem may utilize multiple busses.

Storage subsystem 1130 may be configured to store the basic programming and data constructs that provide the functionality of the present invention. Software (code modules or instructions) that provides the functionality of the present invention may be stored in storage subsystem 1130. These software modules or instructions may be executed by processor(s) 1110. Storage subsystem 1130 may also provide a repository for storing data used in accordance with the present invention. Storage subsystem 1130 may comprise memory subsystem 1140 and file/disk storage subsystem 1150.

Memory subsystem 1140 may include a number of memories including a main random access memory (RAM) 1142 for storage of instructions and data during program execution and a read only memory (ROM) 1144 in which fixed instructions are stored. File storage subsystem 1150 provides persistent (non-volatile) storage for program and data files, and may include a hard disk drive, a floppy disk drive along with associated removable media, a Compact Disk Read Only Memory (CD-ROM) drive, a DVD, an optical drive, removable media cartridges, and other like storage media.

Input devices 1160 may include a keyboard, pointing devices such as a mouse, trackball, touchpad, or graphics tablet, a scanner, a barcode scanner, a touchscreen incorporated into the display, audio input devices such as voice recognition systems, microphones, and other types of input devices. In general, use of the term “input device” is intended to include all possible types of devices and mechanisms for inputting information to computer system 1100.

Output devices 1170 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from computer system 1100.

Network interface subsystem 1180 provides an interface to other computer systems, devices, and networks, such as communications network 1190. Network interface subsystem 1180 serves as an interface for receiving data from and transmitting data to other systems from computer system 1100. Some examples of communications network 1190 are private networks, public networks, leased lines, the Internet, Ethernet networks, token ring networks, fiber optic networks, and the like.

Computer system 1100 can be of various types including a personal computer, a portable computer, a workstation, a network computer, a mainframe, a kiosk, or any other data processing system. Due to the ever-changing nature of computers and networks, the description of computer system 1100 depicted in FIG. 11 is intended only as a specific example for purposes of illustrating the preferred embodiment of the computer system. Many other configurations having more or fewer components than the system depicted in FIG. 11 are possible.

Various embodiments of any of one or more inventions whose teachings may be presented within this disclosure can be implemented in the form of logic in software, firmware, hardware, or a combination thereof. The logic may be stored in or on a machine-accessible memory, a machine-readable article, a tangible computer-readable medium, a computer-readable storage medium, or other computer/machine-readable media as a set of instructions adapted to direct a central processing unit (CPU or processor) of a logic machine to perform a set of steps that may be disclosed in various embodiments of an invention presented within this disclosure. The logic may form part of a software program or computer program product as code modules become operational with a processor of a computer system or an information-processing device when executed to perform a method or process in various embodiments of an invention presented within this disclosure. Based on this disclosure and the teachings provided herein, a person of ordinary skill in the art will appreciate other ways, variations, modifications, alternatives, and/or methods for implementing in software, firmware, hardware, or combinations thereof any of the disclosed operations or functionalities of various embodiments of one or more of the presented inventions.

The disclosed examples, implementations, and various embodiments of any one of those inventions whose teachings may be presented within this disclosure are merely illustrative to convey with reasonable clarity to those skilled in the art the teachings of this disclosure. As these implementations and embodiments may be described with reference to exemplary illustrations or specific figures, various modifications or adaptations of the methods and/or specific structures described can become apparent to those skilled in the art. All such modifications, adaptations, or variations that rely upon this disclosure and these teachings found herein, and through which the teachings have advanced the art, are to be considered within the scope of the one or more inventions whose teachings may be presented within this disclosure. Hence, the present descriptions and drawings should not be considered in a limiting sense, as it is understood that an invention presented within a disclosure is in no way limited to those embodiments specifically illustrated.

Accordingly, the above description and any accompanying drawings, illustrations, and figures are intended to be illustrative but not restrictive. The scope of any invention presented within this disclosure should, therefore, be determined not with simple reference to the above description and those embodiments shown in the figures, but instead should be determined with reference to the pending claims along with their full scope or equivalents.

What is claimed is:

1. A method for treating subjects having viral infections to increase the probability of a predetermined clinical outcome, the method comprising:
administering an antiviral drug to a subject having a viral infection of the liver;
receiving, at an information processing device, viral load of the subject during a first time period, at least one time point in the first time period occurring subsequent to administering the antiviral drug;
determining, with the information processing device, velocity of viral load decline in the subject for the first time period;
predicting, with the information processing device, whether viral load in the subject after a second time period subsequent to the first time period passes a cure threshold based on a non-linear mixed-effects model of liver viral disease modeling the viral load in the subject for the second plurality of time points and the velocity of viral load decline in the subject for the first time period;
altering a dosing regimen associated with the antiviral drug for the subject based on whether viral load in the subject passes the cure threshold.

2. The method of claim 1 wherein determining, with the information processing device, velocity of viral load decline in the subject for the first time period comprises:
calculating the rate at which the viral load in the subject decreases at the at least one time point occurring subsequent to administering the antiviral drug.

3. The method of claim 1 wherein predicting, with the information processing device, whether viral load in the subject after a second time period subsequent to the first time period passes a cure threshold based on a non-linear mixed-effects model of liver viral disease modeling the viral load in the subject for the second plurality of time points and the velocity of viral load decline in the subject for the first time period comprises:
using the model to determine viral load in the subject during one or more time points in the second plurality of time points occurring when viral load in the subject fails to satisfy a limit of quantification.

4. The method of claim 1 wherein predicting, with the information processing device, whether viral load in the subject after a second time period subsequent to the first time period passes a cure threshold based on a non-linear mixed-effects model of liver viral disease modeling the viral load in the subject for the second plurality of time points and the velocity of viral load decline in the subject for the first time period comprises:
simulating viral infection activity and liver activity using the model to determine viral load in the subject during one or more time points in the second plurality of time points.

5. The method of claim 1 further comprising:
determining, with the information processing device, a profile for the subject using the model; and
comparing the profile for the subject to a clustering of members of a population represented by the model.

6. The method of claim 1 wherein the non-linear mixed-effects model comprises a model representing the hepatitis C virus (HCV) or the hepatitis B virus (HBV).

7. The method of claim 1 wherein altering the dosing regimen associated with the antiviral drug for the subject comprises modifying dose of the antiviral drug.

8. The method of claim 1 wherein altering the dosing regimen associated with the antiviral drug for the subject comprises modifying a dose schedule for the antiviral drug.

9. The method of claim 1 wherein altering the dosing regimen associated with the antiviral drug for the subject comprises modifying a treatment duration.

10. The method of claim 1 wherein altering the dosing regimen associated with the antiviral drug for the subject comprises modifying a treatment combination.

11. The method of claim 1 wherein altering the dosing regimen associated with the antiviral drug for the subject comprises removing the antiviral drug from the treatment of the subject and administering a different antiviral drug to the subject.

12. A computer-readable storage medium configured to store one or more software programs which when executed by the information processing device cause the information processing device to perform the steps recited in the method of claim 1.

13. A method performed by an information processing device for assisting in the treatment of subjects having liver viral infections, the method comprising:
receiving, at the information processing device, data for a subject infected with a virus attacking the liver, the data specifying at least viral load in the subject during a first time period where at least one time point in the first time period occurs subsequent to administration of an antiviral drug;
determining, with the information processing device, a rate at which viral load in the subject decreases for the first time period;
predicting viral load in the subject for a second time period that occurs subsequent to the first time period with the information processing device when viral load passes a physical degree of detection based on simulating subject physiology and virus patho-physiology using a non-linear mixed-effects model of liver viral disease; and
generating information with the information processing device suggesting a clinical outcome in response to a correlation provided by the model between the rate at which viral load in the subject declines and when viral load in the subject for the second time period satisfies a predetermined threshold.

14. The method of claim 13 wherein generating information with the information processing device suggesting a clinical outcome comprises generating information indicative of a sustained viral response.

15. The method of claim 13 wherein generating information with the information processing device suggesting a clinical outcome comprises generating information indicative of a partial viral response.

16. The method of claim 13 wherein generating information with the information processing device suggesting a clinical outcome comprises generating information indicative of a null viral response.

17. The method of claim 13 wherein generating information with the information processing device suggesting a clinical outcome comprises generating information indicative of a breakthrough response.

18. The method of claim 13 wherein generating information with the information processing device suggesting a clinical outcome comprises generating information indicative of a relapse.

19. The method of claim 13 wherein receiving, at the information processing device, data for the subject infected with a virus attacking the liver comprise receiving information indicative of initial viral loaders, height, weight, or genotype.

20. A computer-readable storage medium configured to store computer-executable program code operational with a computer system for assisting in the treatment of subjects having liver viral infections, the computer-readable storage medium comprising:
code for receiving data for a subject infected with a virus attacking the liver, the data specifying at least viral load in the subject during a first time period where at least one time point in the first time period occurs subsequent to administration of an antiviral drug;
code for determining a rate at which viral load in the subject decreases for the first time period;
code for predicting viral load in the subject for a second time period that occurs subsequent to the first time period when viral load passes a physical degree of detection based on simulating subject physiology and virus patho-physiology using a non-linear mixed-effects model of liver viral disease; and
code for generating information suggesting a clinical outcome in response to a correlation provided by the model between the rate at which viral load in the subject declines and when viral load in the subject for the second time period satisfies a predetermined threshold.

21. The computer-readable storage medium of claim 20 wherein the code for generating information with the information processing device suggesting a clinical outcome comprises code for generating information indicative of a sustained viral response.

22. The computer-readable storage medium of claim 20 wherein the code for generating information with the information processing device suggesting a clinical outcome comprises code for generating information indicative of a partial viral response.

23. The computer-readable storage medium of claim 20 wherein the code for generating information with the information processing device suggesting a clinical outcome comprises code for generating information indicative of a null viral response.

24. The computer-readable storage medium of claim 20 wherein the code for generating information with the information processing device suggesting a clinical outcome comprises code for generating information indicative of a breakthrough response.

25. The computer-readable storage medium of claim 20 wherein the code for generating information with the information processing device suggesting a clinical outcome comprises code for generating information indicative of a relapse.

26. A system for assisting in the treatment of subjects having acute or chronic viral infections, the system comprising:
means for receiving data for a subject infected with a virus, the data specifying at least viral load in the subject during a first time period where at least one time point in the first time period occurs subsequent to administration of an antiviral drug;
means for determining a rate at which viral load in the subject decreases for the first time period;
means for predicting viral load in the subject for a second time period that occurs subsequent to the first time period when viral load passes a physical degree of detection based on simulating subject physiology and virus patho-physiology using a non-linear mixed-effects model; and
means for generating information suggesting a clinical outcome in response to a correlation provided by the model between the rate at which viral load in the subject declines and when viral load in the subject for the second time period satisfies a predetermined threshold.
